(19) United States
(12) Patent Application Publication
(10) Pub. No.: US 2011/0029428 A1
(43) Pub. Date: Feb. 3, 2011

(54) Mobile Remittance Network

(76) Inventors: Yuh-shen Song, Northridge, CA (US); Catherine Lew, Northridge, CA (US); Alexander Song, Northridge, CA (US); Victoria Song, Northridge, CA (US)

Correspondence Address: Alan Lenkin;Suite 3500, 2029 Century Park East, Los Angeles, CA, 90067-3021, US

(21) Appl. No.: 12/838,154

(22) Filed: Jul. 16, 2010

Related U.S. Application Data
(63) Continuation-in-part of application No. 12/611,862, filed on Nov. 3, 2009.
Application No. 12/611,862 is a continuation-in-part of application No. 10/929,285, filed on Aug. 30, 2004, now Pat. No. 7,636,671.

(51) Int. Cl. G06Q 40/00

(52) U.S. Cl. 705/39

(57) ABSTRACT

A computerized network empowers senders (or payers) to send funds and recipients (or payees) to receive funds at any time anywhere in the world through user-accessible terminals such as ATM terminals, check-cashing kiosks, money services kiosks, cash registers, checkout stands, computers, contactless devices, wire line phones, mobile phones, smartphones, personal digital assistants, etc. Furthermore, the network collects and verifies senders' and recipients' identification information in accordance with the anti-money laundering, anti-terrorist financing, and anti-financial crimes regulatory requirements, such as the Bank Secrecy Act and the USA PATRIOT Act in the United States and any equivalent laws in other countries.

### CROSS REFERENCE TO RELATED APPLICATIONS

This application is a continuation-in-part of U.S. patent application Ser. No. 12/611,862 to Song et al., filed Nov. 3, 2009, which is a continuation-in-part of U.S. Pat. No. 7,636,671, to Song et al., issued Dec. 22, 2005, which claims the benefit of U.S. Provisional Application No. 60/640,859, to Song et al., filed Jan. 3, 2005, the disclosures of which are expressly incorporated by reference herein in their entireties.

### FIELD

The present disclosure relates generally to conducting remittance or payment transactions through networked user-accessible terminals. More specifically, the present invention provides a method and apparatus to effect a computerized transfer of funds from a sender (or payer) at a first terminal, to a recipient (or payee) at a second terminal possibly in another country or region, while providing any involved organizations with verified identification information of both the sender (payer) and the recipient (or payee).

### BACKGROUND

People have many reasons to send money from one location to another. For example, as a result of globalization, people often work at a place far away from home, possibly even in a different country. They often have to send money back to their hometowns in order to support their families or relatives.

The traditional approach of sending money is to use a wire transfer, which requires the recipient to have a bank account. Unfortunately, banking systems are not popular with the general population in many parts of the world and thus many prospective recipients do not have any bank accounts.

To meet this huge market need, Western Union, MoneyGram and many other financial institutions have established branches and agents all over the world. The sender gives money to one of the branches or agents in the sender's area and then the recipient will receive money from one of the branches or agents in the recipient's location area after a proper identification process. Billions of dollars are moving around the world this way every year.

The cost of doing this business is very high because it is a labor intensive process. Most countries have imposed anti-money laundering, anti-terrorist financing, and anti-financial crimes obligations upon financial institutions. These financial institutions have to, for example, (1) verify and record the sender's and recipient's identification information, (2) check the sender and recipient against the “blacklists” published by various governments before completing the transaction, and (3) detect any suspicious activity and report it to the government agencies.

These branches and agents of financial institutions are dependent on manual processing to complete the transaction and to fulfill the anti-money laundering, anti-terrorist financing, and anti-financial crimes requirements imposed by the governments. Furthermore, the branches and agents of the financial institutions are not available everywhere at all times. A sender or a recipient may have to travel a long distance to complete the transaction during the business hours. In case of emergency, there is not much that the sender or the recipient can do to speed up the process.

Governments worldwide are requiring financial institutions to verify and collect at least certain text-based identification information associated with each of the parties to financial transactions in order to enforce anti-money laundering, anti-terrorist financing, and anti-financial crimes laws.

There is thus a need for an automated remittance transaction process which can be automatically performed by user-accessible terminals, 24 hours a day, 7 days a week, and which can be made available almost anywhere in the world.

It has been proposed to conduct remote transactions through ATM terminals using a physical “convenience card” which has been purchased from a vending machine. Such a “convenience card” may then be used to open an account with a sponsoring financial institution before conducting transactions based on this card; however, the “convenience card” does not necessarily identify who the owner of the newly opened account really is; moreover, once the account has been opened, that same “convenience card” can be stolen by or otherwise come into the possession of a criminal or terrorist who can then use the card to send money all over the world to another criminal or terrorist.

Furthermore, it is very difficult for a financial institution to open an account online for a person remotely because the financial institution cannot verify who the remote person is. A fraudster can steal other person's identity to open an account. In fact, identity theft is one of the major financial crimes today.

If the remote person is a resident in the USA or some other developed country, credit report companies may have some records about this remote person and the financial institution can use the information in the credit report to verify the identity of the remote person. For example, based on the information in the credit report, a financial institution can ask the remote person which company has financed the car the remote person purchased two years ago. If the remote person has difficulties in answering these types of questions, it is likely that the remote person is a fraudster.

However, if the remote person is a resident in a developing country or underdeveloped country, no such credit report is available for the financial institution to use. Therefore, it is very difficult for financial institutions to open an account online, especially when the remote applicant has no credit history.

Unfortunately, most remittance transactions are conducted between developed countries and developing (or underdeveloped) countries. Sometimes, even the sender who sends money from a developed country to an underdeveloped country may not have the needed credit history because the sender has only arrived in the developed country for a short period of time which is insufficient to establish a credit history.

In summary, it is often very difficult to verify the identity of either the sender or the recipient in a remittance transaction. Given the fact that identity verification in a remittance transaction is required by anti-money laundering, anti-terrorist and anti-financial crimes laws and regulations, the cost for remittance transactions is very high because of the difficulties in identity verification.

With modern technologies, government authorities can store a great deal of machine-readable personal identification information within or on a person's official identification document such as passport, national identification card, voter card, driver's license, etc. For example, the stored identification information may include biometrical information such as a fingerprint, an iris pattern, a picture, etc., that identifies a particular individual.

In addition, those same government authorities can store conventional text-based identification information associated with that same individual such as the name, date of birth, identification number, social security number and/or address within or on the same official identification document, in a manner that assures that the stored text-based information is properly associated with the same individual as the stored biometrical information.

In this document, the terminology “network” or “networks” generally refers to a communication network or networks, which can be wireless or wired, private or public, or a combination of them, and includes the well-known Internet.

In this document, the terminology “computer” or “computer system” generally refers to either one computer or a group of computers, which may work alone or work together to accomplish the purposes of the system.

In this document, the terminology “computer network” generally refers to either one network or a group of connected networks, which may work alone or work together to accomplish the purposes of the network.

In this document, a “bank” or “financial institution” is generally referred to as a “financial service provider”, which encompasses either a bank or a non-bank where financial services are provided.

In this document, an “account,” “bank account” or “financial account” is generally referred to as an “account in a financial institution”, and encompasses accounts in either a bank or a non-bank where financial transactions are conducted by means of payment instruments such as cash, checks, credit cards, debit cards, ATM cards, stored-value cards, gift cards, wires, monetary instruments, electronic funds transfers, automatic clearing house, etc.

In this document, the terminology “terminal” or “kiosk” generally refers to equipment, including a computer and/or its peripherals, microprocessor and/or its peripherals, ATM terminal, check-cashing kiosk, money services kiosk, merchant checkout stand, cash register, coin exchange machine, parking lot payment kiosk, other payment kiosks, contactless device, wire line phone, mobile phone, smartphone, PDA, digital assistant, entertainment device, network interface device, router, and/or Personal Digital Assistant (PDA), etc., which interfaces a user with a computer network, so that the user may interact with computer systems and other equipment connected to the computer network.

In this document, the terminology “official identification document” generally refers to a passport, a driver's license, a voter card, a benefits card, a national identification card, an identity card, a certificate of legal status, and other official documents and information bearing instruments that identify a designated individual by certain verifiable characteristics, that are issued or certified by a consulate, embassy, government agency, or other governmental authorities, and that are protected against unauthorized copying or alteration by the responsible government. In particular, such “official identification documents” can be formed from various materials, including paper, plastic, polycarbonate, PVC, ABS, PET, Teslin, composites, etc. and can embed the identification information in various formats, including printed or embossed on the document (or card), written on a magnetic medium, programmed into an electronic device, stored in a memory, and combinations thereof. The “identification information” may include, but is not necessarily limited to, names, numbers, date of birth, signatures, addresses, passwords, personal identification numbers, tax identification numbers, national identification numbers, countries that issue the IDs, states that issue the IDs, ID expiration date, photographs, fingerprints, iris scans, physical descriptions, and other biometric information. The embedded information can be read through optical, acoustic, electronic, magnetic, electromagnetic and other media.

In this document, the role of a “sender” in a remittance transaction generally applies to the role of a “payer” in a payment transaction. The role of a “recipient” in a remittance transaction generally applies to the role of a “payee” in a payment transaction. A “remittance” transaction can also be generally referred to as a “payment” transaction. The embodiments in this disclosure can be generally applied to both remittance transactions and payment transactions.

### SUMMARY

One objective of the present invention is to automate the process of remittance and payment transactions using terminals (which in certain embodiments may be located anywhere in the world). Instead of going to financial institutions to conduct remittance and payment transactions, senders and recipients can conduct these transactions at any participating user-accessible terminals, such as ATM terminals, check-cashing kiosks, money services kiosks, merchant checkout stands, cash registers, coin exchange machine, parking lot payment kiosks, other payment kiosks, computers, contactless device, wire line phones, mobile phone, smartphone, PDA, digital assistants, entertainment devices, network interface devices, routers, etc.

Another objective is to remove the traditional need for senders and recipients to appear at a financial institution in person to open an account while at the same time assuring compliance with applicable anti-money laundering, anti-terrorist financing and anti-financial crimes requirements imposed by governments all over the world. Furthermore, a payer can conduct payment transactions for point-of-sale, remote or online transactions without using the traditional payment instruments such as cash, checks, credit cards, debit cards, ATM cards, stored-value cards, gift cards, wires, monetary instruments, electronic funds transfers, automatic clearing house, etc. In this document, although remittance transactions are often used as examples, the present disclosure also applies to payment transactions.

By reading the embedded information from an official identification document, a user-accessible terminal can verify the true identity of a person. For example, a user-accessible terminal can directly read the fingerprint information of a person. If the scanned fingerprint of a person matches the fingerprint information embedded within or on an official identification document, this person must be the official owner of this official identification document. Alternatively, for example, if a person can enter a correct piece of private information such as personal identification number, etc. associated with the official identification document, this person can be authenticated as the owner of this official identification document. As a result, the text-based identification information embedded within and on the official identification document such as name, date of birth, address, social security number, ID number, issuing authority, etc. has been verified and can be used as a token for the identity of that same person.

In one embodiment of the present invention, after verifying the true identity of a sender (or payer), a user-accessible terminal may prompt the sender to deposit funds into the Mobile Remittance Network (“MRN”) for effecting a remittance transaction by means of cash, checks, electronic funds transfers, automatic clearing house, credit cards, debit cards, ATM cards, stored-value cards, gifts cards, wires, or monetary instruments, and combinations thereof, or direct funds transfers from at least (1) one of the sender's financial accounts including checking, saving, trust, brokerage, insurance, credit card, debit card, ATM, stored-value, payment, money services, etc., (2) one of the third parties' accounts, or (3) one of the accounts of the MRN computer system. The funds deposit record is kept by the computer system of the MRN in a database.

The user-accessible terminal may then prompt the sender to provide at least minimal identification information of the recipient. In addition, a Transaction Identification Number (“TIN”) may be issued by the MRN computer system to identify this transaction. The TIN, the transactional details, and the sender's and the recipient's identification information are preferably stored securely within a transactional database of the MRN computer system. The MRN computer system preferably also performs anti-money laundering, anti-terrorist financing, and anti-financial crimes measures according to the laws of the local governments worldwide. In some embodiments, the sender can give the TIN to the recipient by means of telephonic, voicemail, e-mail, text message, instant message, or other communication methods.

In some other embodiments, the MRN computer system can send TIN to the recipient by means of telephonic, voicemail, e-mail, text message, instant message, or other communication method

To leverage on the existing infrastructure, a user-accessible terminal can be integrated as part of an ATM terminal, check-cashing kiosk, money services kiosk, cash register, checkout stand, parking lot payment kiosk, other payment kiosk, coin exchange machine, computer, contactless device, wire line phone, mobile phone, smartphone, PDA, digital assistant, entertainment device, network device, or other type of money-transactional terminals.

The MRN can be integrated with the existing ATM network, credit card or debit card network, Internet, ACH network, SWIFT network, phone network, data network, wire transfer network or other type of private or public network having a level of security suitable for processing financial transactions.

As a result, the recipient can go to any participating ATM terminal, check-cashing kiosk, money services kiosk, cash register, checkout stand, parking lot payment kiosk, other payment kiosk, coin exchange machine, computer, contactless device, wire line phone, mobile phone, smartphone, PDA, digital assistant, entertainment device, or other money-transactional terminals to receive funds based on the commercial arrangements between the MRN and the owners of these networks and/or of the connected user-accessible terminals.

In one embodiment of the present disclosure, after verifying the identity of a claimant using the embedded information of the claimant's official identification document, a second user-accessible terminal preferably prompts the claimant to enter the previously assigned TIN. The MRN computer can perform additional anti-money laundering, anti-terrorist financing, and anti-financial crimes measures based on the additional information provided by the recipient.

Based on this TIN, the MRN computer system may then search its database and locate the transactional details and the recipient's identification information provided by the sender. If the intended recipient's identification information, which has been provided by the sender to the MRN, corresponds to the claimant's embedded identification information, which is stored within or on the claimant's official identification document, the identity of both the sender and the recipient have been properly verified and the user-accessible terminal may then issue the payment to the recipient by means of cash, checks, electronic funds transfers, automatic clearing house, credit cards, debit cards, ATM cards, stored-value cards, gift cards, wires, or monetary instruments, and combinations thereof, or direct funds transfers to at least (1) one of the recipient's financial accounts including checking, saving, trust, brokerage, insurance, credit card, debit card, ATM, stored-value card, gift card, payment, money services, etc., (2) one of the third parties' accounts, or (3) one of the accounts of the MRN computer. In one embodiment of the present disclosure, a computer system receives first embedded identification information from a first official identification document submitted by a sender. A sender's account is associated with a sender's identity.

The computer system also receives recipient identification information, identification information of a recipient's personal communication device, and other transactional details for the funds transfer transaction from the sender. The recipient's identification information, the other transactional details and the identification information of the recipient's personal communication device are associated with a sender's account.

The computer system sends login information to the recipient's personal communication device. The login information is associated with the recipient's identification information, the other transactional details and the sender's account.

The computer system receives second embedded identification information, which is used to verify an identity of a claimant, from a second official identification document submitted by the claimant.

The computer system retrieves the recipient identification information and the other transactional details in response to a login attempt by the claimant. The login attempt is associated with the recipients identification information and the other transactional details.

The computer system permits the claimant to access a recipient's account when the second embedded identification information corresponds to the retrieved recipient identification information. The recipient's account is associated with a recipient's identify.

The computer system authorizes funds transfer from the sender's account to the recipient's account. As a result, the sender and the recipient can complete the funds transfer transaction using the official identification documents of the sender and the recipient in addition to the recipient's personal communication device.

Some embodiments can be used by a group of organizations. A common computer system and transactional database may handle all the remittance and payment transactions for these organizations by sharing the same network of user-accessible terminals. Alternatively, each organization may have its own computer system and transactional database to conduct all the remittance and payment transactions originated from those user-accessible terminals, which are managed by the organization.

In certain embodiments, by using a TIN or login information that identifies the organization or transaction network that has accepted the funds on behalf of the sender, a network switch can readily route a recipient's request for payment to that particular organization or transaction network to complete the remittance transaction.

### BRIEF DESCRIPTION OF THE FIGURES

FIG. 1 illustrates the system and network diagram of an exemplary Mobile Remittance Network (“MRN”), which enables a sender from anywhere in the world to send money to a recipient anywhere in the world at any time.

FIG. 2A-D are flow charts indicating an exemplary manner in which the system and network shown in FIG. 1 automates the remittance transactions.

### DETAILED DESCRIPTION

Although we contemplate that the present invention will in practice be used in many different environments and will be manifested in numerous embodiments, we will describe in detail only a few exemplary presently preferred embodiments of the present invention and certain exemplary combinations of those embodiments.

The Mobile Remittance Network (“MRN”) is established on a computer network, which may preferably connect many user-accessible terminals, such as ATM terminals, check-cashing kiosks, money services kiosks, checkout stands, cash registers, coin-exchange kiosks, payment kiosks, computers, contactless devices, wire line phones, mobile phones, smartphones, personal digital assistants, other digital assistants, entertainment devices, network devices, and other money-transactional terminals. An MRN computer system is preferably provided for processing the transactions, managing accounts, controlling the data exchange, keeping the records, and managing the activities occurring on the MRN.

When a sender (or payer) intends to transfer funds, the MRN verifies his/her identity in order to comply with the requirements of any relevant anti-money laundering, anti-terrorist financing, and anti-financial crimes set by the governments.

In one embodiment of the present invention, the user-accessible terminal reads the embedded identification information of the sender's official identification document such as passport, voter card, national identification card, driver's license, government-issued official identification document, etc. The embedded information may include text-based information such as name, address, date of birth, ID number, ID expiration date, ID issuing authority, ID issuing country, ID issuing state, personal identification number, password, and tax ID, and digitized image-based information such as signature, fingerprint, voice pattern, iris pattern, photo, and facial pattern, etc. The embedded identification information can be read through an electronic media, optical media, acoustic media, magnetic media, electromagnetic media including radio frequency signals, other media or any combination.

In addition, the user-accessible terminal scans or otherwise obtains directly from the sender, a set of personal information or a set of partial personal information, such as personal identification number, password, tax identification number, last four digits of tax ID, private personal information, and biometric information including digitized personal identification image-based information such as a fingerprint, voice pattern, iris pattern, photo, facial pattern, etc.

The user-accessible terminal authenticates the sender's identity by comparing the personal information obtained from the sender with the information embedded within or on the official identification document or the information associated with the embedded information. For example, if the fingerprint of the sender matches the fingerprint information embedded within or on the official identification document, the sender is the official owner of the official identification document. If the social security number submitted by the sender matches the social security number associated with the official identification document, the sender is the official owner of the official identification document. Consequently, the user-accessible terminal can obtain the sender's verified name, address, date of birth, ID number, ID expiration date, ID issuing authority, and any other required information from the sender's official identification document and send that information to the MRN computer system.

Alternatively, in another embodiment of the present invention, the sender's embedded identification information can be sent to the MRN computer and the authentication can be done by the MRN computer. In certain jurisdictions or countries, a person's identity must match the official identification document he/she carries. Sometimes, the regulation does not require money transmitters to authenticate a sender based on an official identification document. Under such circumstances, the mere submission of an official identification document by a sender is sufficient for authentication purposes.

In one embodiment of the present disclosure, the identification information embedded within or on the official identification document of a sender (or payer) can be read and uploaded through the MRN to a computer system which stores the uploaded information in a database. Employees working for the MRN can verify the identity of the sender (or payer) based on the information uploaded by the sender.

For example, a sender can take a picture of his official identification document or scan his official identification document and upload the picture or the scanned image of the official identification document to the computer system of the MRN. In addition, the sender can take a picture of himself/herself and upload the picture to the computer system of the MRN. For example, if the picture on the official identification document corresponds to the picture of the sender, the sender is the owner of the official identification document.

For example, if a scanned fingerprint of a sender matches the fingerprint embedded within or on the official identification document, the sender is the owner of the identification document. Of course, computerized methods or techniques can be applied by the computer system of the MRN to automate the comparisons of fingerprints, pictures, etc.

Once a sender's identity has been verified, the computer system of the MRN can set up an account for the sender.

In another embodiment of the present invention, a human operator interfaces with the sender, verifies the identification of the sender, and uses a computer terminal or equivalent equipment to perform other equivalent functions, which the above user-accessible terminal would perform.

In one embodiment of the present invention, the identification information reading and/or identity authentication device (or capability) described above is incorporated into or attached to equipment such as a computer, contactless device, wire line phone, mobile phone, smartphone, PDA, digital assistant, entertainment device, network device, etc. so that a sender can conduct the remittance transaction with the equipment.

After thus verifying the identity of the sender, the user-accessible terminal will prompt the sender to provide at least certain minimal recipient identification information such as legal name, the official identification document number, last six digits of the official identification number, date of birth, ID issuing authority, etc. Then, the sender can deposit funds into the sender's account on the MRN.

In one embodiment of the present invention, the sender deposits cash into the user-accessible terminal or to a human operator of the terminal. In another embodiment of the present invention, the sender deposits funds by means of check, monetary instrument, wire, credit card, debit card, ATM card, stored-value card, or other financial instruments. In an alternative embodiment of the present invention, the sender gives instructions to transfer funds from one of his/her financial accounts to fund the remittance transaction. In yet another alternative embodiment of the present invention, a third party may fund the remittance transaction through a commercial arrangement with the sender. Alternatively, the sender can transfer funds from an account associated with the MRN.

Once the funds have been received, in one embodiment of the present invention, the MRN computer system will issue a TIN for the sender to keep as his/her record. At the same time, the computer system of MRN stores the TIN, transactional details, the sender's identification information and the sender-supplied recipient identification information into a database. The sender can then inform the recipient (or payee) of the TIN by any conventional means (such as mail, email, instant message, text message, voicemail, telephone, etc).

In another embodiment of the present disclosure, the computer system of the MRN can send the TIN to the recipient through mail, email, instant message, text message, voicemail, telephone, etc.

Alternatively, in another embodiment of the present invention, the MRN computer system will issue a TIN for the sender to keep after the funds have been received by the MRN even if the authentication of the sender has not been completed yet. This situation is possible when a complicated authentication process is used.

In one embodiment, the TIN is a number or an alphanumeric character. In another embodiment, the TIN is a one-dimensional bar code. In an alternative embodiment, the TIN is a two-dimensional bar code. In yet another alternative embodiment, the TIN is a three-dimensional bar code.

In one embodiment of the present invention, once in possession of the TIN, the recipient (or claimant) can go to any participating user-accessible terminal, which connects to the MRN. The user-accessible terminal reads the embedded identification information of the claimant's official identification document, such as passport, driver's license, government-issued ID, etc. After verifying the identity of the claimant, the user-accessible terminal prompts the claimant to provide the TIN, which is used to identify the transaction. The verified identification information and the TIN are then sent to the computer system of MRN. Alternatively, the claimant can enter the TIN first and then submit his/her identification document. Furthermore, the claimant's embedded identification information can be sent to the MRN computer and the verification can be done by the MRN computer. In certain jurisdictions or countries, the mere submission of an official identification document by a claimant is good for verification purposes.

The MRN computer system uses the TIN to locate the record, from which the sender's identification information, the sender-supplied recipient identification information, the transactional details and other relevant information may be extracted.

The MRN computer system then verifies whether the extracted recipient identification information that had been provided by the sender corresponds to the official identification information provided by the claimant.

If the verification is successful, the computer system of MRN approves the delivery of the payment to the claimant as instructed by the sender. If the verification fails, the computer system of MRN informs the user-accessible terminal to reject the transaction.

Sometimes, it is not necessary to have an exact match between the claimant identification information and the recipient identification in order for the MRN computer to approve the delivery of payment to the claimant. For example, the sender may enter the word “Alex” as the first name of the recipient while the official first name of the claimant is “Alexander.” The delivery of payment can still be approved by the MRN computer as long as, based on the best judgment of the MRN computer, the claimant identification information “corresponds to” the recipient identification information supplied by the sender.

In one embodiment, the payment is issued in the form of cash. In another embodiment of the present invention, the payment is issued by means of a stored-value card, credit card, debit card, gift card, mobile wallet device, smart chip, contactless device, monetary instrument, or a check. In yet another alternative embodiment, the payment is issued by transferring funds into one of the recipient's financial accounts including but not limited to checking, savings, certified deposits, trust, brokerage, insurance, ATM card, payment services, money services, stored-valued card, gift card, credit card or debit card accounts, accounts with the MRN computer system, or into third-party accounts as specified by the claimant.

A recipient, instead of sender as described above, can also initiate a funds transfer transaction. In one embodiment of the present disclosure, a recipient can request a payment and the computer system of the MRN will open an account for the recipient after the verification of the recipient's identity and issue a TIN to the recipient.

In one embodiment, the TIN is a number or an alphanumeric character. In another embodiment, the TIN is a one-dimensional bar code. In an alternative embodiment, the TIN is a two-dimensional bar code. In yet another alternative embodiment, the TIN is a three-dimensional bar code.

In one embodiment of the present disclosure, the recipient can provide the TIN to the sender though voice, email, fax, letter, picture, text message, instant message or other communication method. The MRN computer system will open an account for the sender after verification of the sender's identity. The sender will upload the TIN to the computer system of the MRN.

In another embodiment of the present disclosure, the sender can take a picture of the TIN which is presented in a bar code format and upload the TIN to the computer system of MRN.

In an alternative embodiment of the present disclosure, the sender can use a device to read and decode the TIN which is in a bar code format and upload the TIN to the computer system of MRN.

The computer system of MRN will use the TIN to retrieve the recipient information and the transaction details as requested by the recipient and such information will be provided to the sender for approval of the payment.

After the sender authorizes the payment based on the TIN and the transactional details associated with the TIN, the computer system of the MRN will transfer the requested funds from the sender's account to the recipient's account according to the transactional details.

For the purpose of the present disclosure, an “account” can be simply a record associated with the account holder. A “person's account” means that “the account is under the title of the person.” Therefore, money in an account can be simply a figure recorded in the account and the account holder has the authority to use the money.

Therefore, once the funds are moved to the recipient's account and under the recipient's control, in one embodiment, the recipient can receive the payment in the form of cash. In another embodiment of the present invention, the payment can be issued through a stored-value card, credit card, debit card, gift card, mobile wallet device, smart chip, contactless device, monetary instrument, or a check. In yet another alternative embodiment, the payment can be issued by transferring funds into one of the recipient's financial accounts, including but not limited to checking, savings, certified deposits, trust, brokerage, insurance, ATM card, payment services, money services, stored-valued card, gift card, credit card or debit card accounts, accounts with the MRN computer system, or into third-party accounts as specified by the recipient. Of course, the payment can be issued through a combination of different methods.

The above disclosure is not the only way to automate the remittance transaction. Alternatively, in one embodiment of the present disclosure, the sender can submit his/her official identification document for identity verification purposes and the MRN computer can open an account for the sender after the identity verification.

The sender provides the MRN computer system with recipient's identification information and transaction details. In addition, the sender provides the MRN computer system with identification information of the recipient's personal communication device, e.g., mobile phone number, email address, web address, instant message ID, etc. The computer system of the MRN can send login information to the recipient's personal communication device through voice message, text message, email message, instant message, etc.

The login information may include, for example, user ID, password, PIN, or identification information of the recipient's personal communication device, etc. In one embodiment of the present disclosure, the login information is associated with the computer system, the sender's account, the recipient's identification information and the transactional details supplied by the sender.

In another embodiment of the present disclosure, a TIN can be issued by the MRN computer system and sent to the recipient as a part of the login information. The TIN is associated with the computer system, the sender's account, the recipient's identification and the transactional details supplied by the sender.

In one embodiment, a recipient's account is opened and is associated with the login information. In another embodiment of the present disclosure, the recipient's account may not be opened until the recipient claims the payment or has successfully claimed the payment as described below.

In one embodiment of the present disclosure, a claimant attempts to log into the computer system of the MRN based on the login information received from the claimant's personal communication device through email, voice message, text message, instant message, etc.

To prevent identity theft, in one embodiment of the present disclosure, the computer system of the MRN can send a pass code, which will automatically expire after a predefined period of time, to the recipient's personal communication device through email, voice message, text message, instant message, etc. when the claimant attempts to log into the computer system of the MRN. The claimant will be required to enter the correct pass code into the MRN computer in order to login. If the claimant can successfully enter the correct pass code before the pass code expires, the claimant is the intended recipient (or payee) of the transaction.

In one embodiment of the present disclosure, the claimant is required to upload the information embedded within or on the claimant's official identification document. In addition, the claimant is required to upload some personal identification information such as biometrical information (e.g., photo, fingerprint, etc.), user ID, password, etc. of the claimant. This information can be used by the computer system of the MRN for claimant identity verification purposes.

For example, the picture of the claimant and the picture of the claimant's official identification document can be uploaded to the computer system of the MRN. If the picture of the claimant corresponds to the picture on the official identification document, the claimant is the owner of the official identification document.

In one embodiment of the present disclosure, the claimant's account will be automatically associated with the transactional details and the recipient's identification information supplied by the sender because of the login information. The claimant's identity will be verified with the recipient's identification information supplied by the sender.

In another embodiment of the present disclosure, the claimant is prompted by the MRN computer to provide a TIN that is associated with the transactional details and the recipient's identification information supplied by the sender. The claimant's identity will be verified with the recipient's identification information supplied by the sender.

Once the claimant is verified as the correct recipient specified by the sender, the computer system of the MRN will transfer the funds from the sender's account to the claimant's account. The claimant can use the funds through cash, checks, electronic funds transfers, automatic clearing house, credit cards, debit cards, ATM cards, stored-value cards, gift cards, wires, or monetary instruments, and combinations thereof, or direct funds transfers to at least (1) one of the claimant's financial accounts including checking, saving, trust, brokerage, insurance, credit card, debit card, ATM, stored-value card, gift card, payment, money services, etc., (2) one of the third parties' accounts, or (3) one of the accounts of the MRN computer.

Under such circumstances, since the MRN computer opens accounts for senders and/or claimants based on the information remotely uploaded by senders and claimants, it is possible that criminals can steal other persons' identities by uploading counterfeit information to open accounts with the MRN.

To prevent identity theft, the MRN computer can detect the use of counterfeit identification documents or counterfeit photos in the present disclosure. In one embodiment of the present disclosure, since the MRN permits a user (i.e., a sender or a claimant) to conduct commercial transactions with vendors after his/her MRN account is opened, the photo of the account holder can be displayed on vendors' terminals when the user conducts transactions based on the MRN account. These photos can help vendors prevent fraud.

If a photo displayed on the vendor's terminal is different from the appearance of the payer standing in front of the vendor, the vendor can know that the payer is not the owner of the account. A vendor can report fraud to the computer system of the MRN if the appearance of a payer does not correspond to the photo displayed on its terminal.

In another embodiment of the present disclosure, a vendor may enter a piece of information shown on the official identification document provided by the payer. If the information entered by the vendor corresponds to the information stored in the MRN database, the information in the database is further confirmed by this transaction.

By measuring the number of confirmations received from different vendors, the MRN computer system can determine how reliable the information is in the MRN database. As a result, an indicator can be produced to demonstrate the reliability of the information stored by the MRN database regarding a particular user. This indicator can further help the MRN manage its risk regarding this particular user.

If the information entered by the vendor does not correspond to the information stored in the MRN database, either the payer is a fraudster or the information in the database is wrong. The MRN can conduct further investigation to clarify this matter.

As a result, vendors who use the MRN for commercial payment activities help the MRN ensure that no counterfeit identification documents or counterfeit photos are used on the MRN. Since this verification can be naturally done during the vendors' standard fraud prevention processes at point-of-sale transactions, there is no or little overhead in this approach to prevent identity theft.

In one embodiment of the present disclosure, the MRN only officially recognizes the identity of a person after this person has conducted a number of point-of-sale transactions and has passed all identity theft prevention processes performed during these transactions.

In another embodiment of the present disclosure, the MRN only permits limited services to a person before the MRN officially recognizes the identity of the person. For example, the MRN can limit the maximum dollar amount a user can receive through the MRN.

In an alternative embodiment of the present disclosure, the MRN can limit the maximum dollar amount a user can use or send out through the MRN. This is to ensure that the MRN will comply with applicable laws and regulations, including anti-money laundering, anti-terrorist financing and anti-fraud laws and regulations.

In one embodiment of the present disclosure, after the MRN officially recognizes the identity of the person, the person is permitted to use the full scope of services provided by the MRN.

In one embodiment, a computer system and database are used by a single organization to perform all the transactions and to direct all the remittance and payment activities for all the user-accessible terminals of the MRN. In another embodiment of the present invention, each participating organization or a group of participating organizations may use a computer system and database to perform all the transactions and direct all the remittance and payment activities for those user-accessible terminals which are managed by the organization or the group of organizations.

The final settlement will be completed between the organization, which has accepted funds on the sender's behalf, and the organization, which has delivered the funds on the recipient's behalf, according to the convention of the industry. Since the MRN computer system contains the detailed information of both sender and recipient, it can perform anti-money laundering, anti-terrorist financing, and anti-financial crimes procedure as required by the government.

In one embodiment of the present invention, the MRN is integrated with the existing ATM network. In another embodiment of the present invention, the MRN is integrated with the existing credit card or debit card network. In an alternative embodiment of the present invention, the MRN is integrated with the existing Automatic Clearing House (“ACH”) network. In another alternative embodiment of the present invention, the MRN is integrated with other real-time or non-real time networks, including the Internet, phone networks, data networks, etc.

In some presently preferred embodiments, the TIN may incorporate the identification information of an organization (or computer system) holding the funds on behalf of the sender. An included MRN network switch can then use that incorporated organization (or computer system) identification information to direct the recipient's request of payment to the involved organization (or computer system), to complete the remittance or payment transaction.

In some other embodiments of the present disclosure, the login information may contain the identification information of the MRN computer system so that a claimant knows where to login.

In one embodiment, after authenticating the identity of a person, the user-accessible terminal can prompt the person to open an account with a computer system of the MRN and the personal identification information is stored in the database of the MRN.

In another embodiment, a person or an organization can open an account with a computer system of MRN based on the conventional account opening process used in the industry. For example, a person or an organization can submit application forms either in person or remotely and request the computer system of MRN to approve the opening of an account.

An account holder can use his/her official identification document to identify the account. The account can keep funds like a traditional financial account. In one embodiment, the account can be funded with check, monetary instrument, wire, credit card, debit card, gift card, ATM card, stored-value card, or other financial instruments. In another embodiment, the account holder gives instructions to transfer funds from one of his/her other financial accounts to fund the account. In yet another embodiment, a third party may fund the account through a commercial arrangement with the account holder.

The funds can be transferred out from the account to other financial accounts of either the account holder or third parties. These financial accounts include, but are not limited to, checking, savings, certified deposit, trust, brokerage, insurance, ATM card, payment services, money services, stored-valued card, credit card or debit card, gift card accounts, or accounts with the MRN computer system.

As a result, after the account is opened, a person can use the traditional approach (for example, entering user ID and password) to log into the computer of the MRN and conduct remittance and payment transactions on the MRN, as either a sender (payer) or a recipient (payee). The person can conduct the transaction from a terminal such as a computer, ATM, checkout stand, payment kiosk, contactless device, wire line phone, mobile phone, smartphone, PDA, digital assistant, etc. which connects to the computer system of the MRN via a network, such as the Internet, phone network, data network, etc.

In yet another embodiment, after the account is opened, a person can use his/her official identification document to identify his/her account and conduct financial transactions, including payment transactions for any good or services, through a user-accessible terminal connected to the computer system of MRN. The payments are settled based on the commercial arrangements between the computer system of the MRN and the merchants or the respective organizations. As a result, an account holder of an MRN computer system can purchase goods and services by using an official identification document without the need to use the traditional payment instruments, such as cash, checks, wires, monetary instruments, credit cards, debit cards, ATM cards, stored-value cards, gift cards, etc.

In yet another alternative embodiment, an account holder of the MRN computer system can electronically transfer funds to another account holder of the MRN computer system by using a terminal such as a computer, ATM, checkout stand, payment kiosk, contactless device, wire line phone, mobile phone, smartphone, PDA, digital assistant, etc. which connects to the computer system of the MRN via a network, such as the Internet, phone network, data network, etc. As a result, the MRN computer system can also be used as a payment system for both online transactions and point-of-sale transactions.

In one embodiment of the present disclosure, an account holder of the MRN computer system can use his/her official identification document to identify his/her account and withdraw cash from a terminal, e.g., an ATM, which connects to the MRN computer.

In another embodiment of the present disclosure, an account holder of the MRN computer system can use his/her user ID and password to identify his/her account and withdraw cash from a terminal, e.g., an ATM, which connects to the MRN computer.

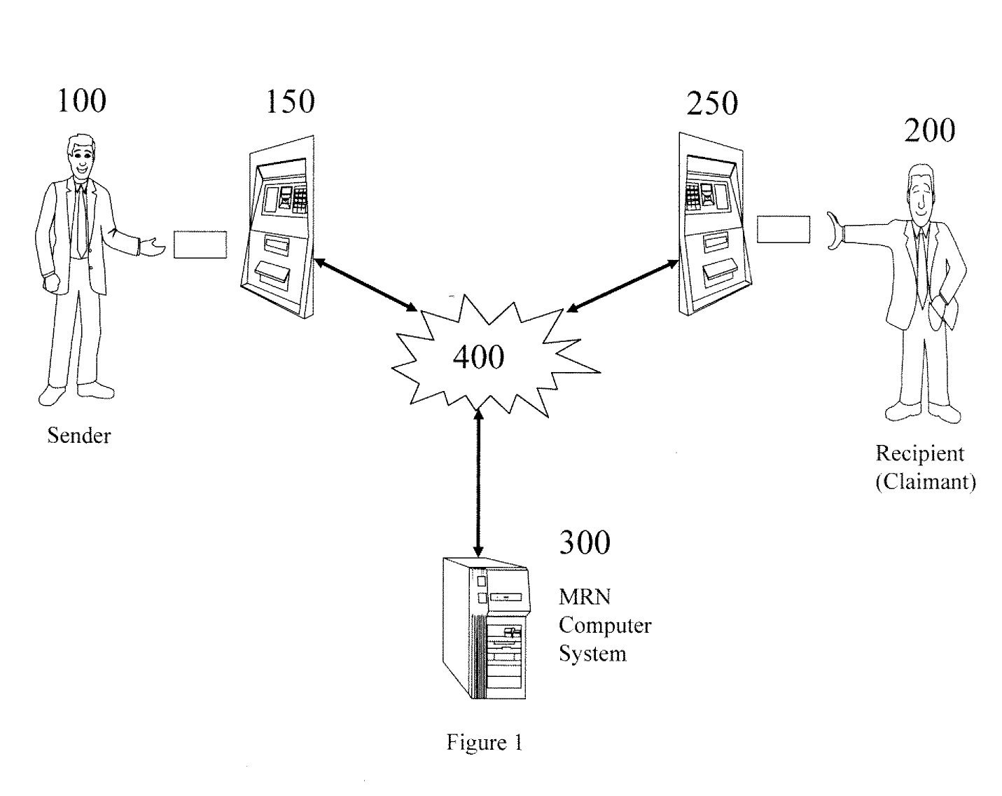

As contemplated in the described embodiments, one of the possible combinations of the preferred embodiments is given below as an example. The Computer System 300 of the MRN enables the sender 100 to send funds to a recipient (claimant) 200 through ATM terminals 150 and 250, respectively, which connects to a network 400 as shown in FIG. 1.

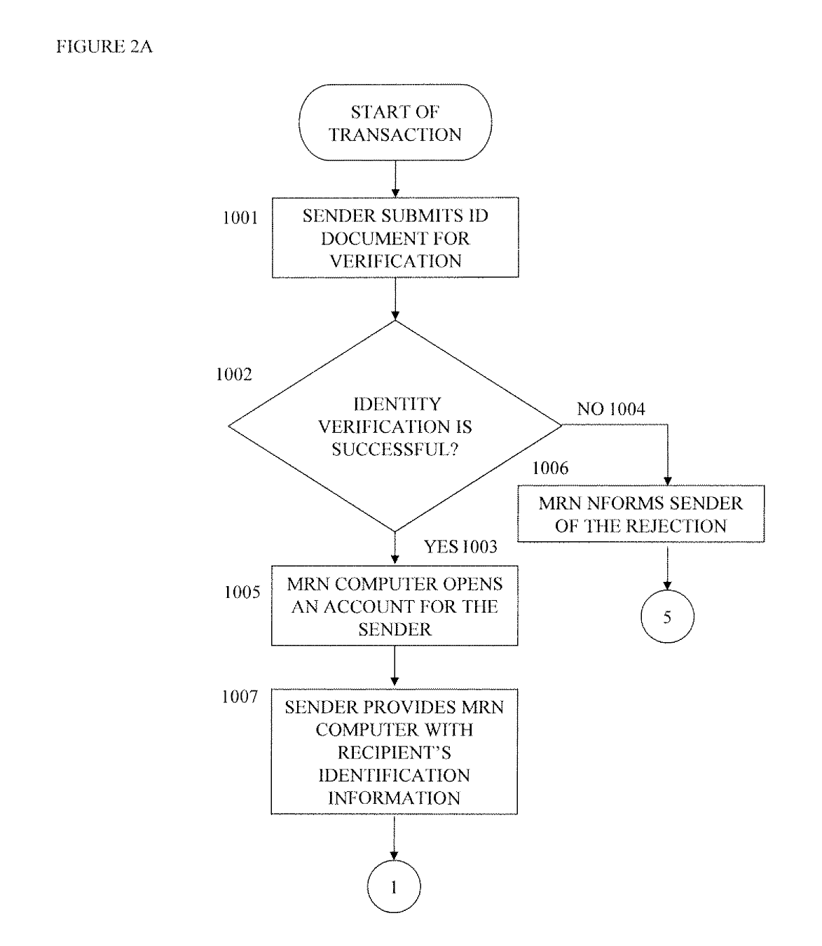

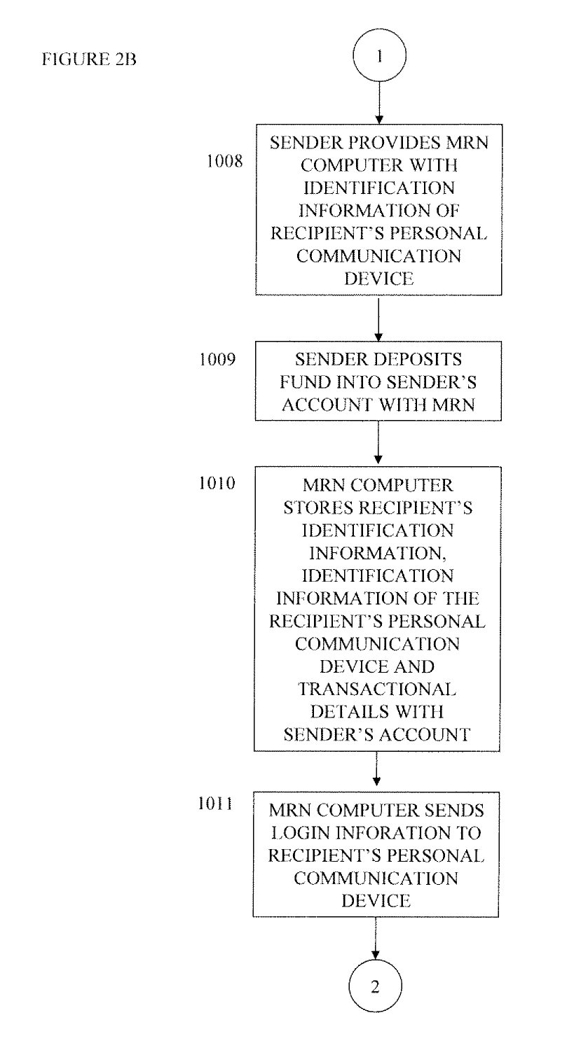

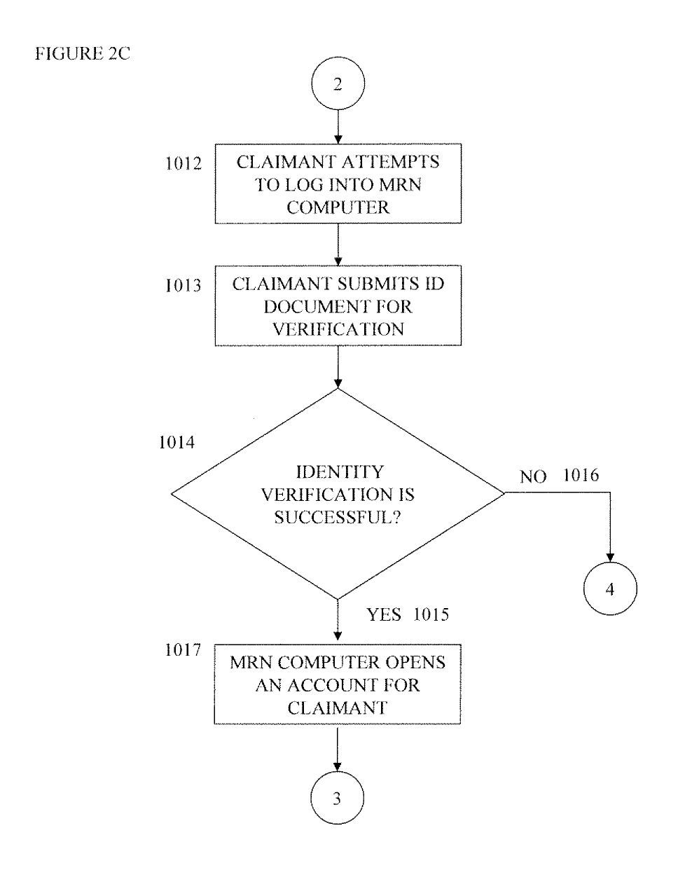

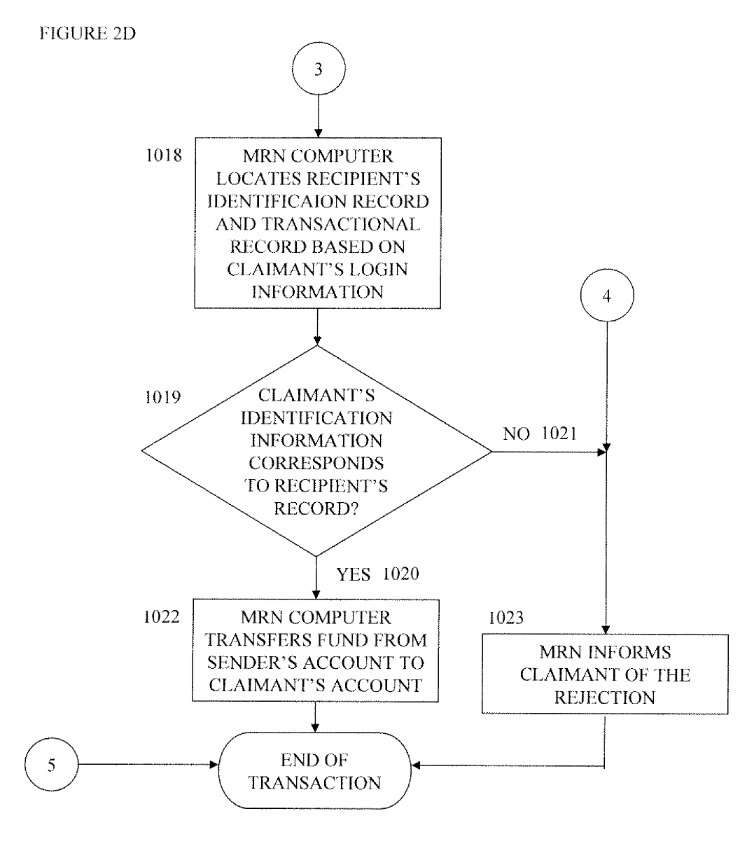

References should now be made to the flowchart of FIG. 2 in combination with the system diagram of FIG. 1, which together illustrate how the system enables a sender to send money to a recipient through the MRN.

First (block 1001), a sender 100 submits a passport or other official identification document to an ATM terminal 150, which can read the embedded identification information of the official identification document. The ATM terminal 150 also reads the sender's the personal identity information, such as a fingerprint, facial pattern, etc., directly from the sender 100.

Then (decision block 1002), the ATM terminal 150 verifies the sender's personal identity information, such as a fingerprint, facial pattern, etc., with the identification information embedded within or on the official identification document of the sender 100. Alternatively, the ATM terminal 150 may send through the network 400 the embedded identification information and the personal identity information of the sender 100 to the computer system 300 which verifies the personal identity information with the embedded identification information.

If the identity of the sender 100 cannot be verified (NO branch 1004), the ATM 150 informs the sender 100 of the rejection (block 1006). This action subsequently ends the transaction.

If the identity of the sender 100 is verified successfully (YES branch 1003), the MRN computer opens an account for the sender 100 (block 1005).

In addition (block 1007), the sender 100 provides the MRN computer system 300 with the identification information of the recipient 200 through the ATM terminal 150.

The sender 100 also provides the MRN computer system 300 with identification information of a recipient's personal communication device (block 1008).

Subsequently (block 1009), the sender 100 deposits funds into the sender's account with the MRN through the terminal 150.

Furthermore (block 1010), the computer system 300 of the MRN stores the identification information of the recipient's personal communication device, the transactional details and the recipient's identification information with a sender's account.

The MRN computer system 300 sends login information to the recipient's personal communication device (block 1011). The login information includes information of where and how to login to the computer system of the MRN 300.

After receiving the login information from a personal communication device such as a mobile phone, smartphone, etc., a claimant 200 attempts to login to the MRN computer system 300 through the ATM terminal 250 (block 1012). As an extra protection against identity theft, the claimant 200 may be required to enter a pass code which was sent to the recipient's personal communication device when the claimant 200 attempts to login to the MRN computer system 300.

In addition, the claimant 200 submits his/her passport or other official identification document to the ATM terminal 250 for identity verification (block 1013).

The ATM terminal 250 (or alternatively, the computer system 300) verifies the personal identity information of the claimant 200, such as a fingerprint, facial pattern, etc., with the identification information embedded within or on the official identification document (decision block 1014).

If the ATM terminal 250 (or alternatively, the computer system 300) cannot verify the identity of the claimant 200 (NO branch 1016), the ATM terminal 250 informs the claimant 200 of the rejection and ends the transaction.

If the identity verification is successful (YES branch 1015), the MRN computer system 300 opens an account for the claimant 200 (block 1017).

Based on the login information (block 1018), the computer system 300 of the MRN locates the records of the transactional details and the recipient's identification information entered by the sender 100.

The computer system 300 of MRN verifies the claimant's identification information, which is read by the ATM terminal 250, with the recipient's identification information in the record, which is entered by the sender 100 (decision block 1019)

If the verification fails (NO branch 1021), the ATM 250 informs the claimant 200 of the rejection (block 1023).

If the verification is successful (YES branch 1020), the MRN computer 300 transfers funds from the sender's account to the claimant's account (block 1022).

This remittance transaction is completed via the ATM terminals 150 and 250, which can be located anywhere around the world. Other types of terminals can also be used for remittance and payment transactions.

In this process, the transactional details and identification information of the sender 100 and the recipient (claimant) 200 are collected in accordance with governments' regulations for the purposes of anti-money laundering, anti-terrorist financing, and anti-financial crimes.

This invention can be used by a group of organizations. A common computer system and database can handle all the remittance and payment transactions for these organizations by sharing the same network of user-accessible terminals. Alternatively, each organization can have its own computer system and database to conduct all the remittance and payment transactions originated from those user-accessible terminals, which are managed by the organization.

By using a TIN or login information that includes the identification information of the particular terminal, organization, shared computer system or other network node which has accepted the sender's funds, a network switch can route a recipient's request for payment to that particular node, computer system, organization, etc. to complete the remittance transaction.

Even though the sender or recipient may not be associated with any account in any financial institution, by requiring that the sender and recipient each use an official identification document, and by appropriate use of the information stored in those documents or instruments to complete the transaction in accordance with the present invention, it is thus possible for such a remittance or payment system to be fully compliant with the regulatory requirements of the Bank Secrecy Act, the USA PATRIOT Act and other equivalent laws. As an additional protection, video cameras can record the activities in the vicinity of the terminals for the purposes of crime prevention.

Those skilled in the art will recognize that the described embodiments can be assembled in various ways to form a variety of applications based on the need, and that obvious alterations and changes in the described structure may be practiced without meaningfully departing from the principles, spirit and scope of this invention. Accordingly, such alterations and changes should not be construed as substantial deviations from the present invention as set forth in the appended claims.

What is claimed:

1. A computerized method for performing a funds transfer transaction from a sender to a recipient through a network of user-accessible terminals, comprising:
receiving first embedded identification information from a first official identification document submitted by the sender, the first embedded identification information, which is used to identify the sender, including an official identification document number, and at least one of a country and state that issued the official identification document, a sender's identity being associated with an account of the sender;
receiving recipient identification information, identification information of a recipient's personal communication device, and other transactional details for the funds transfer transaction from the sender, the recipient's identification information, the other transactional details and the identification information of the recipient's personal communication device being associated with the sender's account;
sending login information to the recipient's personal communication device, the login information being associated with the recipient's identification information, the other transactional details and the sender's account;
retrieving the recipient identification information and the other transactional details in response to a login attempt by a claimant, the login attempt being associated with the recipient's identification information and the other transactional details;
receiving second embedded identification information, which is used to verify an identity of the claimant, from a second official identification document submitted by the claimant;
permitting the claimant to access a recipient's account when the second embedded identification information corresponds to the retrieved recipient identification information, the recipient's account being associated with an identity of the recipient; and
authorizing transfer of funds from the sender's account to the recipient's account,
whereby the sender and the recipient complete the funds transfer transaction using the official identification documents of the sender and the recipient and the recipient's personal communication device.

2. The method of claim 1 further comprising:
performing at least one of anti-money laundering, anti-terrorist financing and anti-financial crimes measures based on a government having jurisdiction over the sender.

3. The method of claim 1 further comprising:
performing at least one of anti-money laundering, anti-terrorist financing and anti-financial crimes measures based on a government having jurisdiction over the recipient.

4. The method of claim 1 further comprising:
permitting the sender to conduct at least one future funds transfer transaction by logging into the sender's account with at least one of a user ID, password, personal identification number, account identification number, national identification number, tax identification number, Identification document number, and any official identification document.

5. The method of claim 4 in which:
permitting the sender to conduct at least one future funds transfer to a recipient by authorizing the funds transfer from the sender's account to the recipient's account based on identification information of the recipient's account.

6. The method of claim 5 in which:
the identification information of the recipient's account includes at least one of a number, alphanumeric character, address, name, description, and symbol.

7. The method of claim 1 further comprising:
permitting the sender to identify the sender's account with any official identification document of the sender or any personal communication device of the sender.

8. The method of claim 1 further comprising:
permitting the sender to transfer funds into the senders account.

9. The method of claim 1 further comprising:
permitting the sender to transfer funds out of the sender's account.

10. The method of claim 1 further comprising:
permitting the recipient to receive at least one future payment by logging into the recipient's account with at least one of a user ID, password, personal identification number, account identification number, national identification number, tax identification number, Identification document number, and any official identification document.

11. The method of claim 10 further comprising:
permitting the recipient to receive at least one future funds transfer to the recipient by requesting the funds transfer from a senders account to the recipient's account based on identification information of the sender's account.

12. The method of claim 11 in which:
the identification information of the sender's account includes at least one of a number, alphanumeric character, address, name, description, and symbol.

13. The method of claim 1 further comprising:
permitting the recipient to identify the recipient's account with any official identification document of the recipient or any personal communication device of the recipient.

14. The method of claim 1 further comprising:
permitting the recipient to transfer funds into the recipient's account.

15. The method of claim 1 further comprising:
permitting the recipient to transfer funds out of the recipient's account.

16. The method of claim 1 in which:
the identification information of a recipient's personal communication device includes at least a number, alphanumeric number, address, name, description, and symbol.

17. A computerized method for performing a funds transfer transaction from a sender to a recipient through a network of user-accessible terminals, comprising:
receiving first embedded identification information from an official identification document submitted by the sender, the first embedded identification information, which is used to identify the sender, including an official identification document number, and at least one of a country and state that issued the official identification document, a sender's identity being associated with an account of the sender;
receiving recipient identification information, identification information of a recipient's personal communication device, and other transactional details for the funds transfer transaction from the sender, the recipient's identification information, the other transactional details and the identification information of the recipient's personal communication device being associated with the sender's account;
sending funds claiming information to the recipient's personal communication device, the funds claiming information being associated with the recipient's identification information, the other transactional details and the sender's account, and including the identification information of a computer system that has the sender's account;
retrieving the recipient identification information and the other transactional details in response to funds claiming by a claimant, the funds claiming being associated with the recipient's identification information and the other transactional details; and
authorizing funds transfer from the sender's account to the claimant in accordance with the other transactional details when second embedded identification information obtained from a second official identification document submitted by the claimant corresponds to the retrieved recipient identification information,
whereby the sender and the recipient complete the funds transfer transaction using the official identification documents of the sender and the recipient and the recipients personal communication device.

18. A computerized method for performing a funds transfer transaction from a sender to a recipient through a network of user-accessible terminals, comprising:
receiving second embedded identification information, which is used to verify an identity of a claimant, from a second official identification document submitted by the claimant;
receiving funds claiming request from the claimant based on funds claiming information, the funds claiming information being sent to a recipient's personal communication device and including identification information of a computer system that sent funds claiming information to the recipients personal communication device and has a sender's account associated with the funds claiming information, recipient identification information, other transactional details defined by the sender and a sender identity obtained from first embedded identification information of an official identification document submitted by the sender, the first embedded identification information including an official identification document number, and at least one of a country and state that issued the official identification document; and
receiving authorization of delivery of payment to the claimant in accordance with the other transactional details when the second embedded identification information corresponds to the recipient identification information, the recipient identification information and the other transactional details being retrieved in response to the funds claiming by the claimant,
whereby the sender and the recipient complete the funds transfer transaction using the official identification documents of the sender and the recipient and the recipient's personal communication device.

19. A computer system for performing a funds transfer transaction from a sender to a recipient, comprising:
a first communication module that receives first embedded identification information from a first official identification document submitted by the sender, the first embedded identification information, which is used to identify the sender, including an official identification document number, and at least one of a country and state that issued the official identification document, a sender's identity being associated with an account of the sender;
a second communication module that receives recipient identification information, identification information of a recipient's personal communication device, and other transactional details for the funds transfer transaction from the sender;
a database that stores the recipient's identification information, the other transactional details, and the identification information of the recipient's personal communication device with the sender's account;
a third communication module that sends login information to the recipient's personal communication device, the login information being associated with the identification information of the recipient, the other transactional details and the sender's account;
a data retrieving module that retrieves the recipient identification information and the other transactional details in response to a login attempt by a claimant, the login attempt being associated with the recipient's identification information and the other transactional details;
a fourth communication module that receives second embedded identification information, which is used to verify an identity of the claimant, from a second official identification document submitted by the claimant; and
an authorizing module that authorizes funds transfer from the sender's account to a recipient's account when the second embedded identification information corresponds to the retrieved recipient identification information, the recipient's account being associated with an identity of the recipient,
whereby the sender and the recipient complete the funds transfer transaction using the official identification documents of the sender and the recipient and the recipient's personal communication device.

20. The computer system of claim 19 in which:
at least one of the first communication module, the second communication module, the third communication module, and the fourth communication module is integrated with one other communication module.

21. A computer system for performing a funds transfer transaction from a sender to a recipient, comprising:
a first communication module that receives first embedded identification information from an official identification document submitted by the sender, the first embedded identification information, which is used to identify the sender, including an official identification document number, and at least one of a country and state that issued the official identification document, a sender's identity being associated with an account of the sender;
a second communication module that receives recipient identification information, identification information of a recipient's personal communication device, and other transactional details for the funds transfer transaction from the sender;
a database that stores the recipients identification information, the other transactional details, and the identification information of the recipients personal communication device with the senders account;
a third communication module that sends funds claiming information to the recipient's personal communication device, the funds claiming information being associated with the recipient's identification information and the other transactional details, and including the identification information of a computer system that has the sender's account;
a data retrieving module that retrieves the recipient identification information and the other transactional details in response to funds claiming by a claimant, the funds claiming being associated with the recipient's identification information and the other transactional details; and
an authorizing module that authorizes funds transfer from the sender's account to the claimant in accordance with the other transactional details when second embedded identification information obtained from a second official identification document submitted by the claimant corresponds to the retrieved recipient identification information,
whereby the sender and the recipient complete the funds transfer transaction using the official identification documents of the sender and the recipient and the recipient's personal communication device.

22. The computer system of claim 21 in which:
at least one of the first communication module, the second communication module, and the third communication module is integrated with one other communication module.

23. A computer system for performing a funds transfer transaction from a sender to a claimant through a computerized network of user-accessible terminals, comprising:
a first communication module that receives second embedded identification information, which is used to verify an identity of a claimant, from a second official identification document submitted by the claimant;
a second communication module that receives funds claiming information from the claimant, the funds claiming information being sent to a recipient's personal communication device and including the identification information of a computer system that sent funds claiming information to the recipient and has a sender's account associated with recipient identification information, other transactional details defined by the sender and a sender identity obtained from first embedded identification information of an official identification document submitted by the sender, the first embedded identification information including an official identification document number, and at least one of a country and state that issued the official identification document; and
a third communication module that receives authorization of delivery of payment to the claimant in accordance with the other transactional details when the second embedded identification information corresponds to the recipient identification information, the recipient identification information and the other transactional details being retrieved in response to the funds claiming by the claimant,
whereby the sender and the recipient complete the funds transfer transaction using the official identification documents of the sender and the claimant.

24. The computer system of claim 23 in which:
at least one of the first communication module, the second communication module, and the third communication module is integrated with at least one other communication module.

25. A terminal for performing a funds transfer transaction from a sender to a recipient through a computerized network, comprising:
a first input device that receives first embedded identification information from a first official identification document submitted by the sender, the embedded identification information, which is used to identify the sender, including an official identification document number, and at least one of a country and state that issued the official identification document;
a second input device that receives recipient identification information, identification information of a recipient's personal communication device, and other transactional details for the funds transfer transaction from the sender; and
a network interface device that connects the terminal through the network to a computer system that stores the identification information of the recipient's personal communication device, a sender identity, the recipient identification information and the other transaction details with a sender's account into a database and sends login information to the recipient's personal communication device, the login information being associated with identification information of the computer system, the sender's account, the recipient's identification information and the other transactional details, so the computer system is able to retrieve the recipient identification information and the other transactional details in response to a login attempt by a claimant based on the login information, and to authorize funds transfer from the sender's account to the claimant in accordance with the retrieved transactional details when the second embedded identification information obtained from a second official identification document submitted by the claimant corresponds to the retrieved recipient identification information.

26. The terminal of claim 25 in which the first input device and the second input device are integrated into a single device.

27. A terminal for performing a funds transfer transaction from a sender to a recipient through a computerized network, comprising:
a first input device that receives second embedded identification information, which is used to verify an identity of the claimant, from a second official identification document submitted by a claimant;
a second input device that receives a login attempt by the claimant based on login information sent to a personal communication device of the recipient by a computer system that associates a sender's account with the login information, identification information of the personal communication device of the recipient, recipient identification information, other transactional details and a sender identity obtained from first embedded identification information of a first official identification document submitted by the sender, the first embedded identification information including an official identification document number, and at least one of a country and state that issued the official identification document; and
a network interface device that connects the terminal through the network to the computer system so that the computer system is able to retrieve the recipient identification information and the other transactional details in response to a login attempt by a claimant based on the login information, and to authorize funds transfer from the sender's account to the claimant in accordance with the retrieved transactional details when the second embedded identification information corresponds to the retrieved recipient identification information.

28. The terminal of claim 27 in which the first input device and the second input device are integrated into a single device.

29. A computerized method for electronically transferring funds from a sender account to a recipient account through an electronic network of user-accessible terminals, comprising:
receiving, from a sender, embedded sender identification information of a first official identification document, recipient identification information, and an address of a recipient's personal communication device;
sending login information to the address of the recipient's personal communication device;
retrieving the recipient identification information in response to a login attempt with the login information;
receiving embedded claimant identification information of a second official identification document; and
authorizing transfer of funds from the sender account to the recipient account when the embedded claimant identification information corresponds to the retrieved recipient identification information.

30. A system for electronically transferring funds from a sender account to a recipient account through an electronic network of user-accessible terminals, comprising:
a receiver that receives, from a sender, embedded sender identification information of a first official identification document, recipient identification information, and an address of a recipients personal communication device; and from a claimant, embedded claimant identification information of a second official identification document;
a transmitter that sends login information to the address of the recipient's personal communication device; and
a processor configured to retrieve the recipient identification information from a storage in response to a login attempt with the login information, the processor authorizing transfer of funds from the sender account to the recipient account when determining the embedded claimant identification information corresponds to the retrieved recipient identification information.

31. A program product, tangibly stored on a computer readable medium for electronically transferring funds from a sender account to a recipient account through an electronic network of user-accessible terminals, comprising:
a sender receiving code segment that receives, from a sender, embedded sender identification information of a first official identification document, recipient identification information, and an address of a recipients personal communication device;
a transmitting code segment that sends login information to the address of the recipient's personal communication device;
a retrieving code segment that retrieves the recipient identification information in response to a login attempt with the login information;
a claimant receiving code segment that receives embedded claimant identification information of a second official identification document; and
a processing code segment that authorizes transfer of funds from the sender account to the recipient account when the embedded claimant identification information corresponds to the retrieved recipient identification information.
